(19) United States
(12) Patent Application Publication
(10) Pub. No.: US 2010/0038607 A1
(43) Pub. Date: Feb. 18, 2010

(54) APPARATUS FOR NAILING T-NUTS

(75) Inventor: Yutaka Nagayama, Kishiwada-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NAGAYAMA ELECTRIC CO., LTD., Osaka (JP)

(21) Appl. No.: 12/540,497

(22) Filed: Aug. 13, 2009

(30) Foreign Application Priority Data
Aug. 13, 2008 (JP) 2008-208423

(51) Int. Cl. B66F 19/00

(52) U.S. Cl. 254/100

(57) ABSTRACT

There is provided an apparatus for nailing t-nut. The apparatus of the invention has a first nailing device. The first nailing device has a push bar; a rotation motion transmission mechanism; a first servo motor for moving the push bar up and down by means of the rotation motion transmission mechanism; a retaining portion to hold a t-nut; an alignment supplier to supply the t-nut to the retaining portion; and a receiving portion to hold a board. The apparatus further has a control device to control the rotation of the servo motor. The t-nut is release by the retaining portion when the push bar moves down. The upper end of the to-nut is pushed by the push bar. The push bar moves down at a speed faster than that of free fall of the t-nut when the retaining portion releases the t-nut, so as to nail the t-nut into the board.

### FIELD OF INVENTION

The present invention relates to an apparatus for nailing T-nuts, and in particular, an apparatus for nailing T-nuts in which T-nuts are easily and assuredly nailed into to-be-nailed material, e.g., a board.

### BACKGROUND OF INVENTION

Where T-nuts are nailed into a board material such as chair or table, conventionally, an apparatus as disclosed in Japanese Laid-Open Patent Publication No. 7-108422 have been used. The conventional apparatus uses an air cylinder to move down a push bar. The conventional apparatus was complicated, and manufacturing cost was high, and the overall size of the apparatus was large.

Moreover, a booster device must be provided at each device for nailing T-nuts, so that the manufacturing cost could be high in this regard, and the size of the overall apparatus was big.

The present invention has been accomplished in view of the above. The objective of the present invention is to provide an apparatus for nailing T-nuts having a simple structure and a compact size, in which it can be manufactured and installed at a lower cost, in which a complicated apparatus such as a booster device and valve device can be removed.

### SUMMARY OF THE INVENTION

There is provided an apparatus for nailing t-nut. The apparatus of the invention has a first nailing device. The first nailing device has a push bar; a rotation motion transmission mechanism; a first servo motor for moving the push bar up and down by means of the rotation motion transmission mechanism; a retaining portion to hold a t-nut; an alignment supplier to supply the t-nut to the retaining portion; and a receiving portion to hold a board. The apparatus further has a control device to control the rotation of the servo motor. The t-nut is released by the retaining portion when the push bar moves down. The upper end of the t-nut is pushed down by the push bar. The push bar moves down at a speed faster than that of free fall of the t-nut when the retaining portion releases the t-nut, so as to nail the t-nut into the board.

As an embodiment, the receiving portion may be provided with a caulking portion, and the t-nut pushed down by the push bar is caulked with the board by the caulking portion.

As an embodiment, the rotation motion transmission mechanism comprises a rack gear and a pinion gear.

As an embodiment, the apparatus may include a second nailing device comprising a second servo motor, wherein the second servo motor is controlled by the control device.

### BRIEF DESCRIPTION OF THE DRAWINGS

FIG. 1 illustrates a plan view of an apparatus for nailing t-nuts of the present invention.

FIG. 2 illustrates a side view of the apparatus for nailing t-nuts of the present invention.

FIG. 3 illustrates a perspective view of an example of a t-nut nailed by the apparatus of the present invention.

FIG. 4 illustrates a bottom view of an example of a t-nut nailed by the apparatus of the present invention.

FIG. 5 illustrates a cross sectional view of an example of a t-nut nailed by the apparatus of the present invention.

FIG. 6 illustrates a process to nail a t-nut by using the apparatus of the present invention.

FIG. 7 illustrates a plan view of a process to nail a t-nut by using the apparatus of the present invention.

FIG. 8 illustrates a cross-sectional view of the board material to which a t-nut is nailed by using the apparatus of the present invention.

FIG. 9 illustrates a t-nut nailed by the apparatus of the present invention.

FIG. 10 illustrates a cross-sectional view of the board material to which a t-nut is nailed by using the apparatus of the present invention.

FIG. 11 illustrates another example of a t-nut nailed by the apparatus of the present invention.

FIG. 12 illustrates a cross-sectional view of the board material to which a t-nut is nailed by using the apparatus of the present invention.

### DETAILED DESCRIPTION OF THE INVENTION

Hereinafter, an embodiment of the apparatus for nailing t-nuts of the present invention is explained with reference to the drawings.

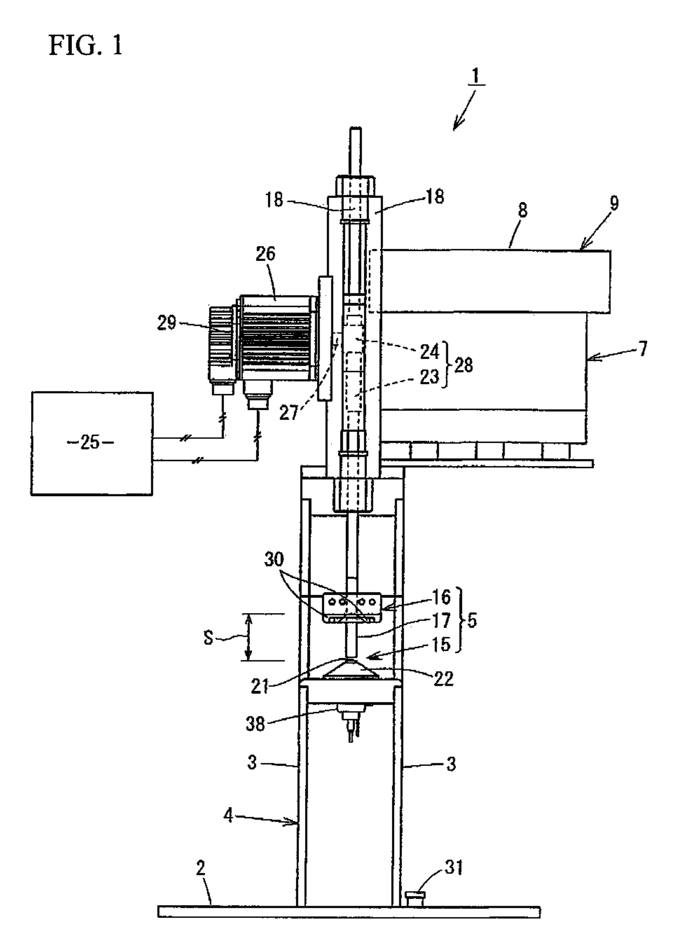

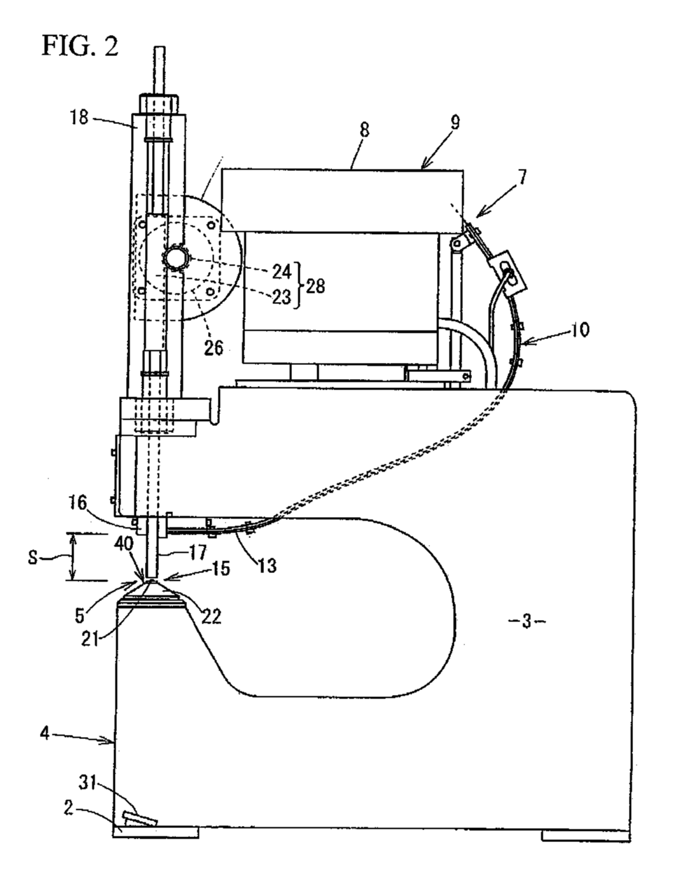

FIG. 1 is a plan view illustrating the apparatus for nailing t-nuts, and FIG. 2 is a side view thereof. In the drawings, reference number 1 shows the apparatus for nailing T-nuts as a whole.

This apparatus for nailing t-nuts is an apparatus that allows t-nuts to be nailed in a material as explained below. It has a base plate 2; a frame 4 made of a pair of side plates 3 provided from the base plate 2 such that they stand thereon; nailing portion 5 provided on the frame 4; and an alignment supplier 7 for supplying t-nuts to the nailing portion 5 in an alignment manner.

The alignment supplier 7 has a t-nut storage tank 9 whose top portion can be opened as inlet port; and shooter 10 for supplying t-nuts. T-nuts are stored in the t-nut storage tank 9. T-nuts are supplied to the nailing portion 5 in an alignment manner by using a supplier nailing device (not drawn in the drawings).

The t-nut storage tank 9 is supported by a support material 11 at a higher position than the nailing portion 5. The shooter 10 includes a pair of rails 13 facing each other. Each rail has a cross section to hold the peripheral portions 12 of the t-nuts 6 to guide the t-nuts, as disclosed in JP Laid Open Patent Publication No. 6-277956. The rails are extended from the supply inlet (not illustrated) of t-nut storage tank 9 to the nailing portion 5.

The nailing portion 5 is provided between a pair of side plate 3, 3 constituting the frame 4. Each side plate has a cross section of C character. The nailing portion 5 has a receiving portion 40 for receiving a material 14 (e.g., a bottom plate to form a seating portion of a chair). The nailing portion 5 has a caulking portion 15 to caulk t-nuts. The nailing portion 5 has a retaining portion 16 to hold t-nuts which are supplied through the shooter 10, the retaining portion 16 being located above the caulking portion 15. The nailing portion 5 has a push bar 17 to move up and down, in order to nail t-nuts as penetrating the retaining portion.

The push bar 17 is provided with a guide support 18 at the high portion of the frame 4. The push bar 17 is supported on the guide support 18 in a sliding manner. The middle thereof is provided with a nailing mechanism 19 to moving up and down the push bar 17.

On the other hand, the receiving portion 40 has a sensor 38 to detect whether a material 14 is supplied. The caulking portion 15 has a guide chip 21 fixed on the top of the stand 22 such that an caulked portion 20 of t-nuts 6 is pressed and enlarged.

The nailing mechanism 19 has a rack gear 23 positioned at the middle of the push bar 17 supported by the guide support in such a manner to move up and down. A pinion gear 24 is provided to engage with the rack gear 23, and is connected to a driving shaft 27 of a servo motor 26 whose rotation is controlled by a control device 25.

The rack gear 23 and the pinion gear 24 form a rotation motion transmission mechanism 28 to transfer the rotation of the driving shaft 27 of the servo motor 26 into a linear motion.

The control device 25 turns on or off the servo motor 26. The number of the driving shaft 27 of the servo motor 26 (i.e., amount and speed of the moving up or down of the push bar 17) is controlled by the encoder 29 provided on the driving shaft 27 of the servo motor 26 located opposite to the side of the pinion gear.

The retaining portion 16 holds t-nuts 6 supplied through the shooter 10. The retaining portion 16 has a pair of support portions 30 for opening and closing in a sliding manner. As the push bar 17 moves down, the retaining portion 16 is opened to release t-nut 6 that is retained by the retaining portion 16.

In the drawings, the reference number 31 is a foot switch for generating a signal for moving down the push bar 17, which is connected to the control device.

A t-nut is nailed into a material by using the apparatus 1 of the present invention as follows:

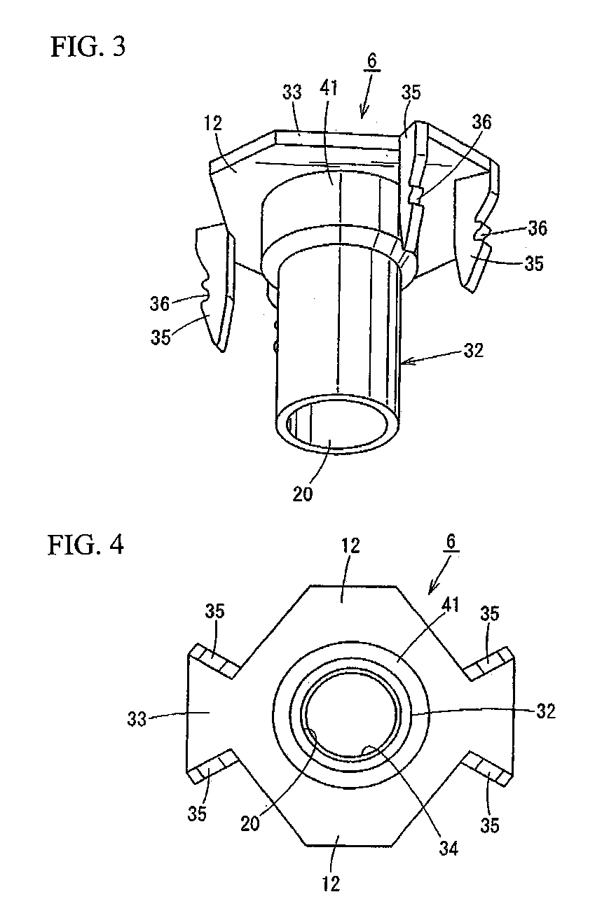

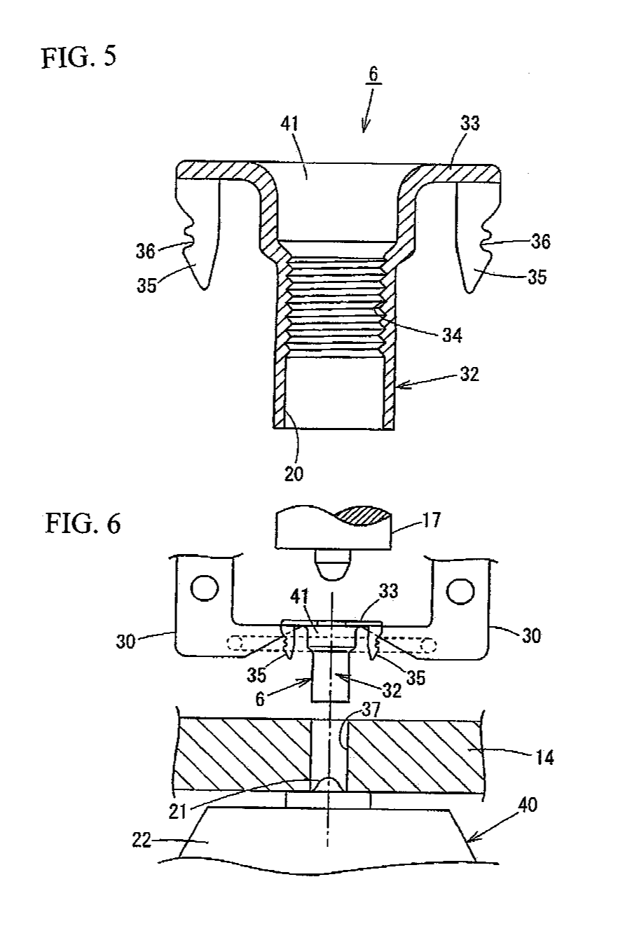

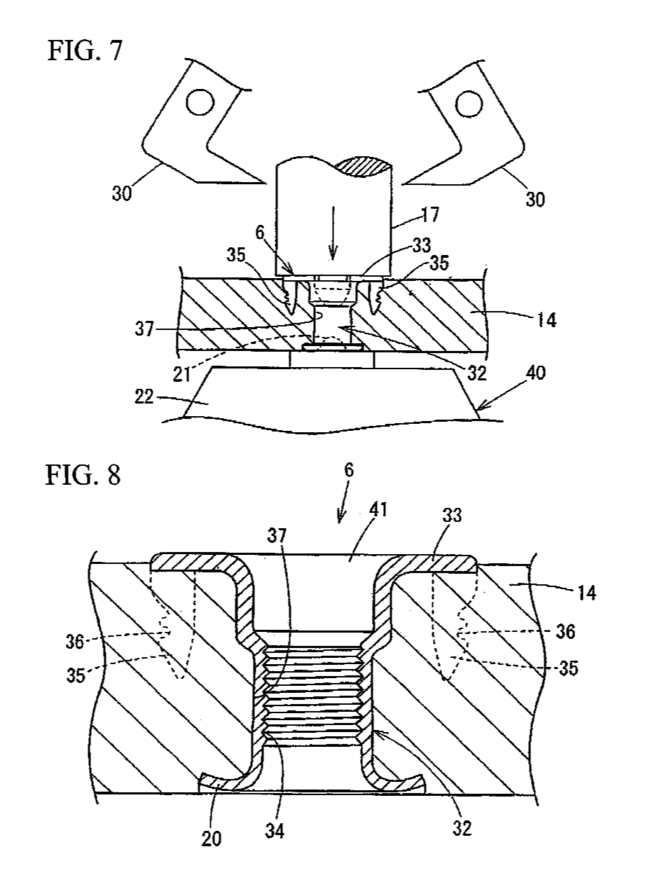

As illustrated in FIGS. 3 to 5, a t-nut 6 is prepared by pressing a metal board such as iron metal board. A t-nut has a shank 32 and a flange 33 outwardly extended from a top portion of the shank 32.

The shank 32 has a cylindrical portion having a large outer diameter portion and a small outer diameter portion. The shank has a caulked portion 20 that can be enlarged when being caulked at the lower end. The lower end of the shank 32 is opposite side of the top portion having the flange. A female screw 34 is formed on the inner surface of the shank 32 except for the caulked portion 20.

The caulked portion 20 is a thinner portion than the portion forming the female screw 34 on the inner surface of the shank 32.

Therefore, when a female screw is formed, a scraping process can be applied either from the top portion of the larger outer diameter of the shank 32 or the lower, thinner portion of the caulked portion 20.

The flange 33 has a pair of claws 35 for avoiding the rotation. Claws are formed by bending a periphery of the flange portion 33, such that each claws facing at an angle of 180°. Since the outer peripheries of the claws 35 has a saw-like shape 36, the claws can firmly engage with the material when the t-nut is nailed into the material 14.

The procedure for nailing the t-nut 6 into a material by using the apparatus of the invention is explained below.

First, a hole 37 is formed on the desired portion of a material 14.

Then, as shown in FIG. 6, the material 14 is set on the receiving portion 40 of the apparatus of the invention such that the hole 37 is concentric to the guide chip 21 of the caulking portion 15 of the apparatus. The sensor 38 detects that the material 14 is set appropriately.

At this stage, right under the push bar 17 of the caulking portion 15, a t-nut 6 is supplied from the t-nuts storage tank 9 through the shooter 10 to the retaining portion 16.

Next, after the sensor 38 detects the material is set, the foot switch is pushed to turn on. Then, the control device 25 supplies current to the servo motor 26 instantly to rotate the servo motor 26 at a high speed at a large output.

When the servo motor is rotated, the push bar 17 moves down by means of the pinion gear 24 and the rack gear 23.

The speed and amount of the moving of the push bar is set with respect of current value and rotation number on the control device 25. The speed and amount of the moving of the push bar are monitored by feed-back manner to the control device 25 by means of a rotary encoder every time when a caulking process is performed.

As the push bar 17 moves down, the retaining portion 16 opens, and the t-nuts 6 held by the retaining portion 16 is released to try to do free fall. Without the action of the push bar 17, the t-nut released by the retaining portion 16 would have dropped as free fall.

In the present invention, the push bar 17 moves faster than the speed of free fall of the t-nut by the action of the servo motor 26. The push bar 17 moves down compulsory and quickly at a high speed. The push bar 17 moves down. The tip portion of the top of the push bar is inserted in the shank portion 32, while the upper surface of the t-nut 6 is pushed by the push bar 17. The shank portion 32 is inserted in the hole 37 until the lower surface of the flange portion 33 is partially engaged in the upper surface of the portion 14.

When the t-nut 6 is nailed in the hole 37, the caulked portion 20 made of a thin material is outwardly enlarged by the guide chip 21 of the caulking portion 15, so as to be engaged with the lower surface of the material.

Also, the claws 35 formed on the flange portion 33 are deeply engaged with the upper surface of the material 14 to avoid rotation. As shown in FIG. 8, the t-nut 6 is firmly fixed on the material 14 by the caulked portion. The caulked portion is enlarged at the lower surface of the material 20 together with the claws 35 of the flange 33 deeply engaged with the inside of the material 14.

Then, the servo motor 26 reversely rotates. The rotation motion transmission mechanism 28 of the rack gear 23 and the pinion gear 24 moves up the push bar 17 to close the retaining portion 16. At that time, the retaining portion 16 holds the next t-nut 6 automatically that is preparing the next process of nailing.

Then, the to-be-nailed portion 14 is removed from the caulking portion 15, and the process to nailing the t-nut 6 in the material is finished.

As understood by the explanation supra, the apparatus for nailing t-nuts of the present invention controls the rotation of the servo motor 26 by the control device 25. The rotation of the servo motor 26 is transferred into a sliding movement of the push bar 17 by means of the rotation motion transfer mechanism. Single control device 25 can be connected with several servo motors 26. Single control device 25 can control several units of servo motor 26.

The control device 25 can be commonly used, resulting in reduction of the space, energy, manufacturing cost and running cost.

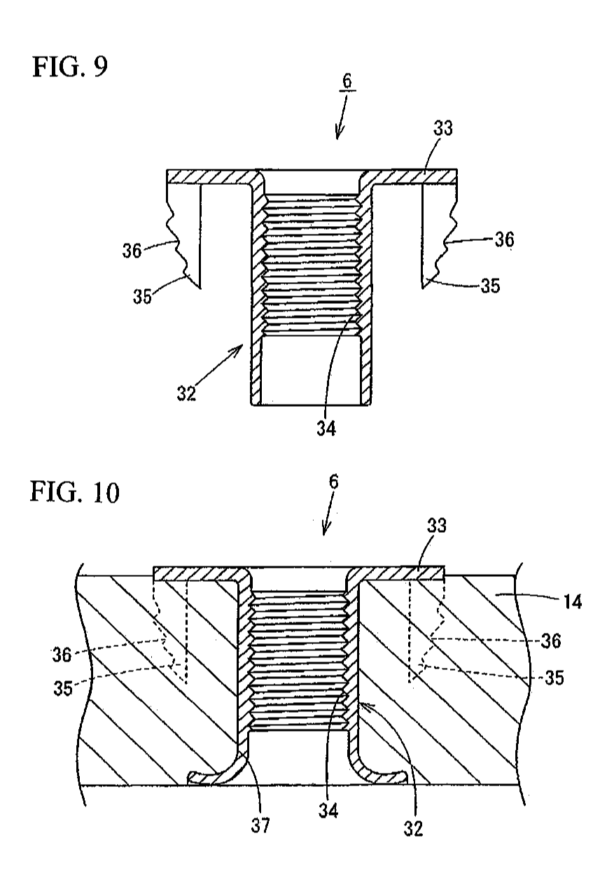

In the embodiment above, as illustrated in the drawings, the shank portion 32 has a large outer diameter portion and a small outer diameter portion, and small outer diameter portion of the shank 32 has formed a caulked portion 20 that is caulked with a female screw 34. It is, of course, to modify this embodiment by removing the large outer diameter portion 41 at the side of the flange portion 33, like Japanese laid open patent publication No. 6-323315. See FIGS. 9 and 10. Also, in the embodiment in the present invention, the rotation motion transfer mechanism 28 is composed of a rack gear 23 and a pinion gear 24, but the present invention is not limited thereto. For example, the upper portion of the push bar 17 is provided with a cam, which can be rotated by a servo motor 26 in order to move up and down the push bar 17.

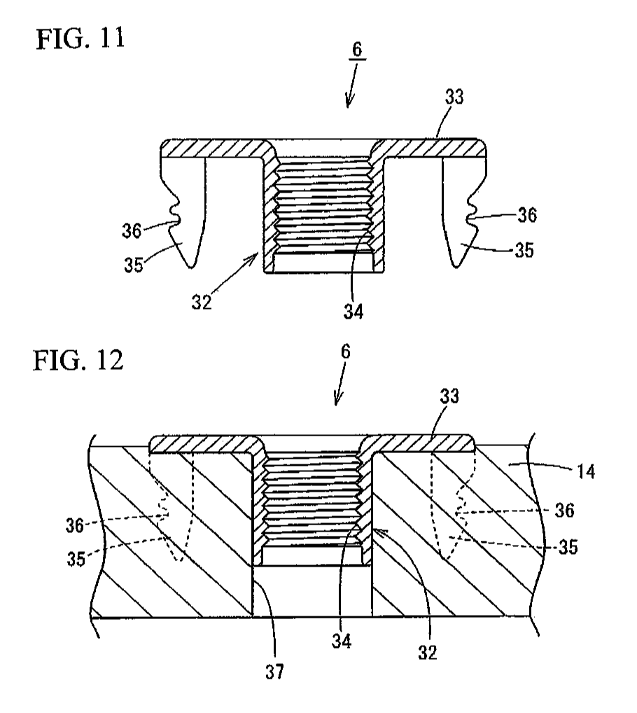

Also, while the embodiment is designed to nail t-nuts 6 with caulked portion 20, the present invention is not limited thereto. For example, as shown in FIG. 11, the shank 32 of the t-nut 6 can be provided with a female screw on its inner surface without a caulked portion 20, to which the apparatus for nailing t-nuts of the present invention can be used.

In such a case, the caulking portion 15 of the nailing portion 5 of the apparatus of the present invention can be removed.

For convenience, some of the reference numbers in the drawings are summarized:
1: apparatus for nailing t-nuts
5: nailing portion
6: t-nut
7: alignment supplier
9: t-nut storage tank
15: caulking portion
17: push bar
20: caulked portion
23: rack gear
24: pinion gear
25: control device
26: servo motor
27: output shaft of servo motor
28: rotation motion transmission mechanism
32: shank portion
33: flange portion
34: female screw
35: claw
40: receiving portion

What is claimed is:

1. An apparatus for nailing t-nut, comprising:
a first nailing device comprising:
a push bar;
a rotation motion transmission mechanism
a first servo motor for moving the push bar up and down by means of the rotation motion transmission mechanism;
a retaining portion to hold a t-nut;
an alignment supplier to supply the t-nut to the retaining portion; and
a receiving portion to hold a board;
a control device to control the rotation of the servo motor;
wherein the t-nut is released by the retaining portion when the push bar moves down, wherein a upper end of the t-nut is pushed down by the push bar, wherein the push bar moves down at a speed faster than that of free fall of the t-nut when the retaining portion releases the t-nut, so as to nail the t-nut into the board.

2. An apparatus for nailing t-nut according to claim 1, wherein the receiving portion has a caulking portion, wherein the t-nut pushed down by the push bar is caulked with the board by the caulking portion.

3. An apparatus for nailing t-nut according to claim 1, wherein the rotation motion transmission mechanism comprises a rack gear and a pinion gear.

4. An apparatus for nailing t-nut according to claim 1, further comprising a second nailing device comprising a second servo motor, wherein the second servo motor is controlled by the control device.
